(19) United States
(12) Patent Application Publication
(10) Pub. No.: US 2013/0190092 A1
(43) Pub. Date: Jul. 25, 2013

(54) CONTROL DEVICE FOR A GAME CONSOLE AND A METHOD FOR CONTROLLING A GAME CONSOLE

(71) Applicant: Christopher Adams, Hamburg (DE)

(72) Inventor: Christopher Adams, Hamburg (DE)

(73) Assignee: GOODBUY CORPORATION S. A., Vaduz (LI)

(21) Appl. No.: 13/582,632

(22) PCT Filed: Mar. 1, 2011
(86) PCT No.: PCT/EP11/52997

§ 371 Date: Nov. 13, 2012

(30) Foreign Application Priority Data
Mar. 4, 2010 (EP) EP10155536.5

(51) Int. Cl. A63F 13/06

(52) U.S. Cl. CPC A63F 13/06
USPC 463/37

(57) ABSTRACT

A control device (10) for a game console comprising a housing (11), an electronic control element arranged in the housing (11), input elements (15, 16, 17) arranged on the housing (11) and connected to the control element, and a data-transmission unit for transmitting control data to the game console, is to be further developed such that it can be used for a flexible application with a real musical instrument in order to convert the latter into an operating tool for a game console. Preferably, the control device (10) is also intended to allow for other usage options, in particular a conventional use for controlling the game console via buttons and switches. For this purpose, it is suggested that the housing (11) have a sensor section (14) in which input elements in the form of sensor fields (15) are arranged in a number corresponding to the number of strings (3) of a lute-like instrument and at a spacing corresponding to the spacing between the strings (3) of the lute-like instrument, the game control device (10) being configured such that it can be arranged with the sensor section (14) below the strings (3) of the lute-like instrument such that each sensor field (15) lies below a string (3) associated with said sensor field (15) without touching said string, and the sensor fields (15) being configured to register a spacing between the respective associated string (3) and the sensor field (15).

### TECHNICAL AREA

The present invention relates to a control device for a game console with the features from the preamble of claim 1. In addition, it relates to a method of generating control signals in order to control a game console.

For the purposes of this invention, the term “game console” refers to any microprocessor-controlled data processing device that can be connected to control devices via corresponding interfaces, and that is suited for game software or interactive learning software processes. In particular, this includes consoles that are specially developed for these purposes such as those sold by the major manufacturers Nintendo, with its console traded under the brand name Wii®, SONY with the PlayStation® series and Microsoft with the XBOX®, but also conventional personal computers which, with the corresponding software, can be also used for interactive games or learning programs.

### PRIOR ART

In order to control a game or learning program, game consoles of this kind typically require a control device or multiple such control devices, which are connected to the game console via data-transmission units. Those connections may be formed, in particular, with cables and thus as a wired connection, however wireless connections may also be formed. The control devices are designed either as universal control devices for controlling various games and learning programs, e.g. in the form of so-called joysticks or similar manipulators with standardized switch or control knob arrangements, where said switches or control knobs trigger an action in the programs depending on the software being controlled. There are, however, also special control devices that have been specifically developed and designed for use with specific software. Thus for example, there is a game sold under the brand name GUITAR HERO®, which simulates the playing of an electric guitar in a rehearsal or concert situation. For this game, a control device was built having an external form that is perceived to be the shape of a typical electric guitar and which is provided with appropriate control knobs and switches, which is connected to the respective game console, and which is used exclusively for controlling this specific computer game.

In addition, while the external shape of the control device does indeed draw on the guitar as its model, its use cannot be compared with playing a real guitar.

Here, in order to approach reality substantially more closely and in order to use a real instrument to simulate playing a guitar on a game console, U.S. Pat. No. 5,990,405 proposes using an instrument, especially a guitar, to control a video game on a game console, in which the electro-acoustic output signals (i.e. audio signals) of the instrument are used and evaluated in a special control device, and the control signals for the game console are generated based on this evaluation of the audio signals.

In this manner, it is possible to use a real instrument to control the execution of a program that simulates the playing of an instrument. There are, however, limitations to this solution. First of all, the control unit that evaluates the acoustic signals produced on the instrument in order to generate control signals for use by the program for the game console is a very specific unit that can be used only for this purpose. In addition the options for use are limited to specific instruments. This is because the sounds actually played on the instrument must be picked up and supplied to the control device, which evaluates these sounds to generate control signals therefrom for the game console. These instruments may include electric guitars, electric basses or other instruments with built-in electro-acoustic transducers, whereby an appropriate cable or the equivalent is connected to the output that outputs the electrically converted signals and is supplied to the control device. Instruments that do not have an integrated electro-acoustic transducer must be provided with costly microphones or similar transducers for this purpose, which are then connected to the actual control device via cable connections or the equivalent. The person using the instrument to control the program running on the game console thus loses freedom of movement because of the cabling, or freedom of movement is certainly limited.

Moreover there are also difficulties in terms of evaluating acoustic signals that are created by the instruments during play in order to generate the corresponding control signals from them. In the virtual applications described in U.S. Pat. No. 5,990,405, what is at issue is specifically the generation of a melodious sound creation in virtual play, even when the actual instrument is not placed precisely. This requires a complicated evaluation of the actual tones in order to distinguish which tones should actually be played and reproduced accordingly by the program. Due to the many possibilities of generating a “wrong note”, it is understandable that it is not possible to simply recognize the game intent of the person using the instrument to operate the game console and to convert the same into a corresponding sequence in playing the virtual instrument on the game console.

In U.S. Pat. No. 5,393,926, a method is disclosed in which a virtual world is controlled by signals generated by playing a guitar having a MIDI transducer. Here too, the same problems exist as described above.

### SUMMARY OF THE INVENTION

The objective of the invention is to remedy this by creating a simple and convenient control device for a game console that allows the flexible use of a real musical instrument in order to convert the same into an operating tool for a game console, in which this device also allows for other potential uses, e.g. conventional use as a game console controller using buttons and switches. Thus the invention essentially represents a flexible method of generating control signals in order to control a game console using an instrument.

This object is accomplished according to the invention by a control device having the features of claim 1. Advantageous further embodiments of such a control device are presented in the dependent claims 2 to 10. A method according to the invention for generating control signals in order to control a game console using an instrument is characterized in Claim 11. Claim 12 refers to an advantageous further embodiment of the same.

The basic idea behind the control device for a game console according to the invention is that this control device has a housing in the normal manner, an electronic control element arranged in the housing, input elements arranged on the housing and connected with the control element, and a data-transmission unit for transmitting control data to the game console. The control device has a sensor section in the housing in a manner according to the invention, in which sensor fields are arranged for the specific use and the interaction with a lute-like instrument, together with which that instrument forms a control device for controlling specific applications on a game console, typically playing a virtual lute-like instrument. The sensor fields are arranged in a number and with spacing from one another that correspond to the number and spacing of the strings of the lute-like instrument. These sensor fields form input elements, which are operated by manipulating the strings of the lute-like instrument. For this purpose, when the control device with the sensor section is arranged on a lute-like instrument, the sensor fields are distributed below the strings such that each of the sensor fields lies below the string associated therewith, without touching the string. The sensor fields are configured in so as to register the spacing between the respective associated string and the sensor field. This spacing comprises the actual input. The same is transmitted as a signal from the respective sensor field to the electronic control element, which uses that input to extrapolate control data for the game console and for the program being run thereon.

A lute-like instrument for the purpose of this invention is to be understood as a broader sense definition that originates from the field of organology. According to that definition, lute-like instruments are those instruments that comprise a resonance box and a neck that supports strings, and on which, the strings run parallel to the top of the resonance box. In particular, according to this definition, lute-like instruments include guitars, violins, fiddles, basses, banjos etc. In the understanding of the invention, this definition is extended to include especially the electric variants of such instruments, especially electric guitars, electric basses, electric violins, etc.

In the case of the control device according to the invention, the acoustic tones produced when the lute-like instrument is played are not captured and evaluated in order to control the program running on the game console, but rather, the spacing of the respective string on the lute-like instrument from the sensor field is used as input and “raw data” in order to generate control signals for the game console. The measurement of the spacing is carried out in the typical manner and preferably in two stages, namely a static measurement of the spacing and a dynamic measurement. The static measurement of the spacing is specifically performed and evaluated in a first step when an operator presses one (or more) of the strings to the neck of the lute-like instrument in order to shorten the strings and set the desired tone for the following articulation of the string. The resulting shortening of the distance between the string and the sensor field disposed therebelow is registered via the sensor arrays(s) in the latter. Two pieces of information can be derived from this initial change in spacing (static nature): Firstly, it is expected that the operator will very shortly strike the thus shortened string in a following step in order to create a sound with it. Furthermore, the reduction in distance, which increases the higher up the neck the player presses the string (i.e. the higher the tone that the player intends to play), can already be used to make an initial pre-selection of a tone that is to be played, and initial preliminary instructions can be sent to the program on the game console.

The second aspect, the dynamic measurement of the spacing, is then performed when the string is actually articulated. Then the string vibrates, resulting in regular changes in the spacing. These changes in spacing are then used to determine that the tone should now be played, and thus a trigger signal is sent so that a virtual tone is played on the game console. Moreover, the amplitude of the deflection, and therefore the difference between the closest and furthest string from the sensor field, can be evaluated in order to adjust the volume of the virtually generated tone. The greater the amplitude, the louder the tone should be played. The force of the attack and therefore the “pitch” of the tone can be determined from the decay behavior. Finally, an evaluation of the change in spacing over time can be used to determine the actual frequency of the vibrating string, and therefore the tone that was actually played, and to pass additional information about it to the game console for the generation of a virtual tone.

All of this information and data are therefore not obtained by recording and registering an actual sound or tone produced by the instrument, but instead by merely evaluating the spacing and by additional analysis of the spacing data. This especially makes it easier to select the tones to be reproduced in the virtual game. Thus in particular, it is possible to select windows or ranges using the software, for example by setting the degree of difficulty, in order to select an exact target frequency or the proper hand position and playing style of the lute-like instrument, within which the tone is reproduced clearly and as a correctly played tone in the virtual playing of the instrument. It is only outside of this window that a “clinker” and false note will also occur in the virtual playback of the instrument, in order to identify an error for the player. This opens up the possibility that windows in the game software on the game console can be variably adjusted, e.g. through the possible specification of varying degrees of difficulty in which at higher degrees of difficulty, the window is set closer to the actual note or fingering that is to be played on the lute-like instrument. In this way, a program of this kind can be used in conjunction with a user's real instrument as a learning program for learning how to play a lute-like instrument (e.g. the violin or guitar) without the user becoming frustrated by mistakes and fingerings that are not correctly positioned. By continuously decreasing the size of the window over time, thus increasing the degree of difficulty, the player of the lute-like instrument must play the real lute-like instrument with an increasing level of accuracy for the virtual playback so that ultimately, the player learns the skills to confidently play the lute-like instrument. In conjunction with the appropriate software on a game console, the control device according to the invention therefore also has a pedagogic effect and use.

When the strings of the lute-like instrument are made out of an electrically conductive material or contain such material, for instance if the same are wrapped with such a material, the measurement of the spacing may be performed in the sensor fields, in particular with sensor arrays designed for inductive distance measurement. Inductive measurements of the spacing are known from prior art and can be realized with comparatively small components and a high degree of precision and temporal resolution. Here, the change in the current flow or the voltage curve in a current flux is evaluated using changes evoked by the conductive object (here, the string) moving towards and away from the electromagnetic field generated by the sensor arrays.

In order to not only be able to register the movement and change in the spacing of a string in a direction that is largely perpendicular to a reference plane (typically the plane within which the strings are running or the surface of the neck) and evaluate that movement for the game console, but also register and evaluate transverse string movements (i.e. within the specified plane), it is advantageous when, for each sensor field, two sensor arrays are arranged transversely, offset to one another, above the sensor field in the intended arrangement of the control device with the sensor section and below the strings of the lute-like instrument, which may in particular be those that are used to measure inductive distance. This allows transverse movements and distortions (so-called ‘bending’ which is used to change the note being played on a vibrating string by up to a half tone), to be used to change the tone when playing a guitar for example, especially an electric guitar. The detection of the direction and scale of this additional movement makes a more comprehensive and realistic control of the game console or of a virtual, interactive program for playing a lute-like instrument possible.

It is particularly advantageous that the control device according to the invention may feature conventional control buttons and/or D-pads as additional input elements (in addition to the sensor fields). Conventional, in this sense, means in particular that D-pads or control buttons are provided that are arranged and that have functions assigned in a manner that corresponds the standardized embodiment of control devices used with the current game consoles. Such an embodiment not only makes the control device according to the invention suitable for use in connection with a lute-like instrument, but for use to control other interactive programs running on the game console, and therefore for use as a universal control device. At the same time, the control device has been specially and advantageously furnished with an essentially osteoid housing having a flat center section that forms the sensor section, and with widened outer sections as compared with the flat center section. The additional control buttons and/or D-pads can be arranged according to the standard specifications for the conventional controllers for the current game consoles in widened outer sections, which are advantageously designed to be ergonomic for gripping with the right and left hand. The control device can then be disposed on the lute-like instrument with the flat center section below the strings so that each string lies across from the associated sensor field without touching the same. The control device is specifically arranged in the area of the sound box (body) of the lute-like instrument.

The control device according to the invention is equipped with a power supply disposed in the housing, especially a rechargeable battery. This allows the control device to be used independent of electrical supply lines. In order for it to be possible to charge the electrical power supply with electrical power, the control device is preferably equipped with a charging connector for connecting with a charging cable. This connection can also be established with a data connection, e.g. in the form of a USB 2.0 connector.

The data-transmission unit preferably features a transmission channel for the wireless transmission of control data to the game console. This wireless transmission channel can operate on any of the known current standards, especially Bluetooth or an IR interface and the corresponding protocol. The formation of the transmission channel for the wireless transmission of the control data to the game console is advantageous especially when the control device is to be used in conjunction with the lute-like instrument. Thus, a cable connection to the control device is unnecessary, and the lute-like instrument can be used freely by the person playing without any cable connection, which, for example, allows movements in a virtual rock concert to correspond those on the stage without the player's movement being impeded by the wire.

The electronic control element will preferably be a microprocessor.

In order to affix the control device to the lute-like instrument, the control device preferably has a releasable fastening elements on the bottom for removable attachment to the lute-like instrument. These fastening elements may be, inter alia, miniature suction cups, double sided adhesive tape, a Velcro band, etc.

The method according to the invention for generating control data in order to control a game console, as is specified in claim 11, may be advantageously carried out using a control device as described above. It is also possible, however, to permanently attach the corresponding sensors and electronic components to the lute-like instrument and to integrate these when the instrument is constructed so that the lute-like instrument is already constructed as a type of “hybrid” with the possibility of actual playing, and with integrated elements that make it possible to connect the instrument to a game console and to use it as a control device for the console. The elements that need to be introduced into the lute-like instrument are consistently different than those that may be used to register the acoustic the acoustic signals (the actual sound) such as pickups on an electric guitar.

### BRIEF DESCRIPTION OF THE DRAWINGS

Further advantages and features of the invention will become apparent from the following description of an embodiment with reference to the accompanying figures. Shown are:

FIG. 1 is a representation of the body-side portion of an electric guitar as an example of a lute-like instrument, equipped with a control device according to the invention in a first variant embodiment,

FIG. 2 shows an enlarged detail from the view in FIG. 1 for a more detailed representation of the control device arranged below the strings of the electric guitar,

In a detail comparable to the detail in FIG. 2, FIG. 3 shows a control device arranged on the electric guitar in a second embodiment,

FIG. 4 shows the second embodiment of the control device removed from the guitar for the manual control of the game console using the conventional control buttons,

FIG. 5 shows two views (a) and (b), that show different positions of a string of the electric guitar relative to a sensor field of the control device where the string is in an unengaged state (5a), and where it is pressed down on a fret in a shortened state (5b), and

FIG. 6 presents a schematic diagram of the structure for registering the distance of the string from the sensor field and the further processing and transmission of the data this obtained by the control device.

### MODE(S) FOR IMPLEMENTING THE INVENTION

With reference to the accompanying schematic representations, which depict two different variant embodiments of a control device according to the invention with a different presentation and arrangement, the invention in the form of the control device as well as a method of generating control data for a game console will be presented in greater detail below by way of example.

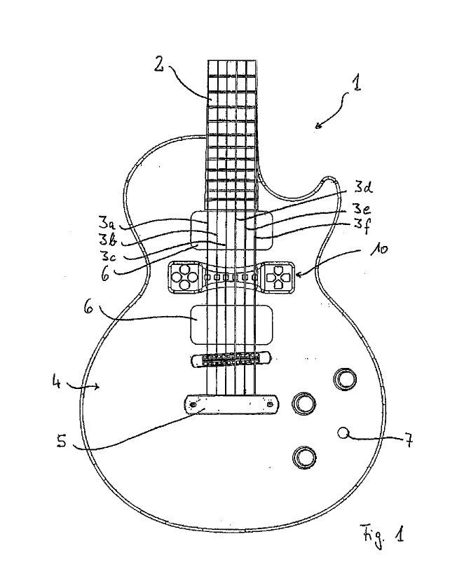

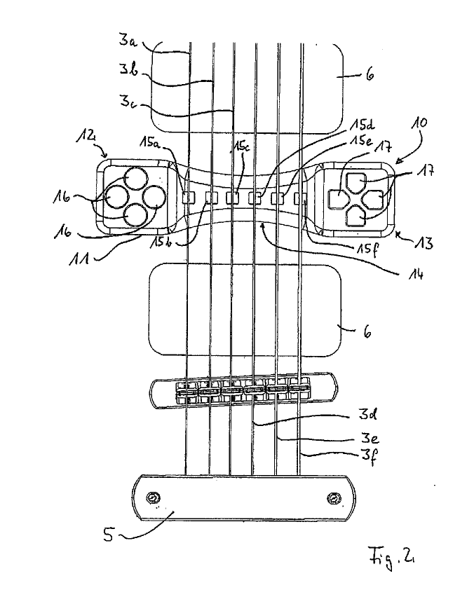

FIG. 1 shows a detail of an electric guitar 1 on which a control device 10 in a first variant embodiment is disposed. The electric guitar 1 is a conventional and a relatively well-known lute-like instrument, which is especially suitable as a real guitar. As is typical for electric guitars, which are presented here as an example of the entire the field of application for the invention with other lute-like instruments, it is equipped with a neck 2, along which a total of six strings 3a-3f extend. The strings 3a-3f extend onto the body 4, which is connected to the neck 2, and to a fixing device 5 where they are fixed at one end. The other end of the strings extends to the other end of the neck 2 (not shown here) to tuners on the head, with which the strings can be tightened and loosened, and therefore tuned.

On this model of electric guitar 1, there are two electro-acoustic transducers, so-called pickups 6 arranged under the strings 3a-f, with which the sound of the vibrating strings 3a-f are converted into an electrical signal that can be registered and fed to an amplifier via a connection.

The control device 10 is removably arranged on the electric guitar 1 under the strings 3a to 3f so that the electric guitar 1 can be played in order to produce real music in the conventional manner without having the control device 10 mounted on it.

In order for it to be possible to attach the control device 10 to the body of the guitar 4, the device has a structure on the underside (not shown here), in particular small suction cups, with which it can be removably fixed in position on the electric guitar 2.

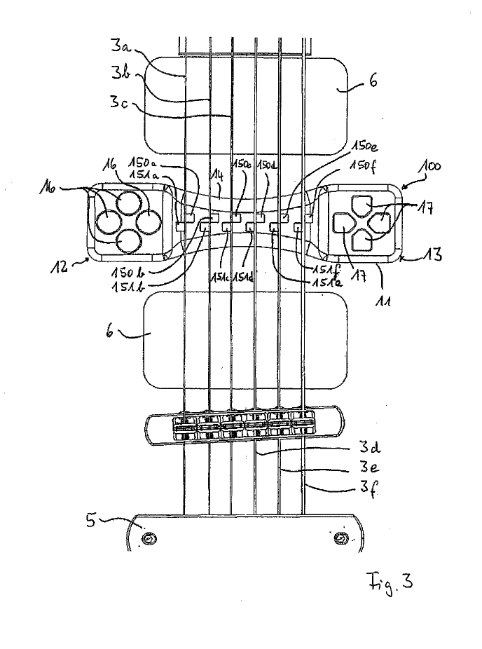

The control device 10, once again shown as an enlarged detail in its arrangement on the body of the guitar in FIG. 2, in conjunction with the electric guitar 1, only serves the extended use of this electric guitar 1 to create control signals for a game console. In particular, the aim is to control a virtual lute-like instrument in a program running on the game console, especially a virtual electric guitar, and to determine the virtual sound production. Virtual sound production does not necessarily mean a sound sequence artificially created on a synthesizer, but may also comprise a series of actually recorded sound sequences that are selected by the game software depending on the game circumstances. This is dependent on the game software itself, however. The control device 10 may be attached to the electric guitar 1 and used to control the game console using the guitar 1 as an input device, independent of the type of software.

FIG. 2 presents an enlarged detail showing the arrangement of the control device 10 under the strings 3a-3f on the body of the electric guitar between the pickups. Here it can be clearly seen that the control device 10 has an osteoid housing 11 with enlarged and thickened side sections 12 and 13, and a tapered and shallower sensor section 14 between these that beneath the strings 3a-3f of the electric guitar when the control device is disposed on the instrument, and above which the strings 3a-f vibrate freely and run at a distance from the sensor section 14.

Arranged in the sensor section 14 are fields with sensor arrays 15a-15f that are placed so as to be spaced apart from one another so as to each lie below the respective associated string 3a-3f when the control device 10 is correctly attached to the body of the electric guitar. Thus in the in the correctly mounted state of the control device 10 as shown in FIG. 2, sensor array 15a lies beneath string 3a, sensor array 15b lies beneath string 3b, sensor array 15c lies beneath string 3c, sensor array 15d lies beneath string 3d, sensor array 15e lies beneath string 3e, and sensor array 15f lies beneath string 3f. The sensor arrays 15a-15f are configured to determine the spacing of the respective associated string 3a-3f from this sensor array 15a-15f or to output different signals when the spacing changes. In the preferred sample embodiment, the sensor arrays 15a-15f thereby include inductive proximity sensors (distances sensors), as known in prior art and as frequently used in many other applications. These sensors each contain a resonant circuit, which electrical power causes to oscillate and generate a local electromagnetic field. The strings 3a-3f on the electric guitar are made out of a conductive material or are covered with such material, primarily so as to be able to function together with the pickups 6. Changing the position of the respective, associated string 3a-3f in the electromagnetic field generated by the corresponding resonant circuit in the sensor array 15a-15f results in feedback in this field, which changes the field. This change in the field, in turn, results in feedback to the current and voltage supply of the resonant circuit and may be evaluated as a signal for a change in position, thus in a change in the spacing of the respective string 3a-3f relative to the associated sensor array 15a-15f. These signals from the evaluation of the spacing or the change in spacing are passed from the sensor arrays 15a-15f to the electronic control element (not depicted here), which is disposed in the housing 11 of a control device 10, where said control element is, in particular, a microprocessor. There, the incoming data is evaluated and from this data, control signals are generated in a manner to be described hereinafter, which are transmitted to a game console in a readable format (e.g. in accordance with MIDI format specifications). For this purpose, the control device 10 also features a data-transmission unit, disposed within the housing 11, that can process wireless data in particular. The data is then transmitted to a corresponding receiver on the game console, for example using the Bluetooth protocol or an infrared protocol. Disposed on the housing 11 is also a self-sufficient energy supply, in particular a rechargeable battery, which supplies both the microprocessor and the sensor arrays and additional elements and functions of the control device 10 with electrical energy. This rechargeable battery can be supplied with electrical energy and recharged externally via a charging connector (not shown here) on the housing 11. In addition to the wireless transmission device, the control device 10 may also have a connector for a data transmission cable, e.g. according to the USB standard (currently USB 2.0).

Furthermore it can be seen that the control device 10 has manually operated control elements in the side sections 12 and 13. Thus a total of four round-shaped button switches 16 are disposed in section 12, which correspond to the normative guidelines of console manufacturers for control devices and connected with a signal output, in order to be able to use the control device 10 separate from the electric guitar in a manner to be described hereinafter as a conventional manual control for the game console. In the same way, there are four additional button switches 17 in the side section 13 that together constitute a D-pad. These also correspond to the normative guidelines of console manufacturers, so that they may be used for the “conventional” control of a game console by manually manipulating the control device according to the invention.

FIG. 3 shows a representation similar to that in FIG. 2 of a second sample embodiment of a control device 100. The fundamental structure of this embodiment essentially corresponds to that of control device 10, so that here, identical reference numbers are used in FIG. 3 as were used in FIG. 2 and reference can be made to FIG. 2 for the parts and their basic function. The internal structure of the control device 100 is similar to that of the control device 10 in FIG. 2, so that the above also applies in this regard.

The control device 100 differs from the control device 10 only in the design of the sensor fields below the strings 3a-3f formed by the sensor arrays 15a-15f in the case of the control device 10. While in the case of control device 10, each sensor field is equipped with a single array 15a-15f, which is to be centrally disposed below the string, in the embodiment according to the control device 100, the sensor fields, each of which are to be associated with the strings 3a-3f, each feature two sensor arrays 150a-150f and 151a-151f. The sensor arrays associated with each string, e.g. the sensor arrays 150a and 151a with respect to string 3a, are offset from one another, arranged both in a longitudinal and in a transverse direction relative to the course of the string 3a. In this sample embodiment, both sensor arrays of a sensor field also include inductive proximity sensors (distance sensors), with which a change in the position of the string relative to the respective sensor arrays causes a corresponding signal output to the sensor in the manner already described above. By choosing two sensor arrays 150a-150f and 151a-151f for the respective strings 3a-3f, this arrangement can be used to register not only changes in the spacing of the string in a direction that is perpendicular to the gradient plane of the sensor section 14, but can also register transverse changes. This type of embodiment makes it possible to determine which effects are wanted by a player playing the lute-like instrument, and in which the strings are pushed laterally on the neck above the respective fret (so-called bending). This bending changes the pitch of the note being played, and tremolo effects, etc., can be played in this manner. Due to the evaluation of two distance signals for each string 3a-3f (generated by the respective sensor array pairs, 150a-151a to 150f-151f), the control device 100 is also able to register this string movement, to perform a corresponding signal analysis in the microprocessor, and to transmit a signal corresponding to such a game to the to the game console, which can react accordingly and adjust the virtual playing of the lute-like instrument.

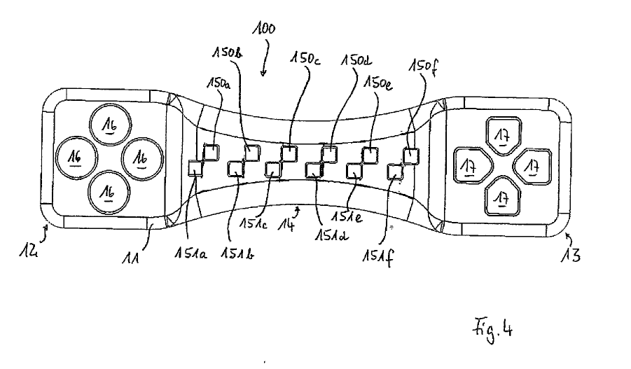

FIG. 4 shows an example of the second embodiment of the control device 100 detached from the lute-like instrument. In this variant, it can be used to control standard and conventional games on the game console through the operation of the control buttons 16 and 17 and transmission of the corresponding control signals derived from this operation being sent to the game console. To this end, the control buttons 16 and 17 are respectively provided in a standardized manner so as to be able to interact with a game console in a manner compatible with conventional game controllers. For this, the microprocessor in the control device 100 communicates with the game console using standard interfaces, whether it is wireless (e.g. Bluetooth), or whether it be via a wired interface (e.g. USB). The sensor arrays 150a-150f and 151a-151f are irrelevant to this function and are not used. The ergonomic, osteoid embodiment is particularly advantageous for the “hand-held” use of the control device 100, since the device is held on either side 12 and 13 with both hands and there, the control buttons 16 and 17 can be operated with the thumbs of the hands, for example.

The previously discussed, fixed arrangement of the control device 10 or 100 below the strings 3 of the lute-like instrument for use in connection with the latter is important in order to achieve a consistent and correct calibration of the sensor fields arranged beneath the strings 3a to 3f. After the control device 10 or 100 is arranged on the guitar, a calibration must be performed since the arrangement will be at a slightly different position each time. To this end, each of the strings 3 are pressed down at one or two predetermined positions (frets) on the neck and the respective associated sensor array 15 of the sensor arrays 150,151 registers the change in spacing. Based on known curves of how different fingering on the frets change the spacing of the strings from the body, a calibration curve can be determined and a conclusion drawn about the fingering of the person playing based on a specific distance of the string from the sensor array.

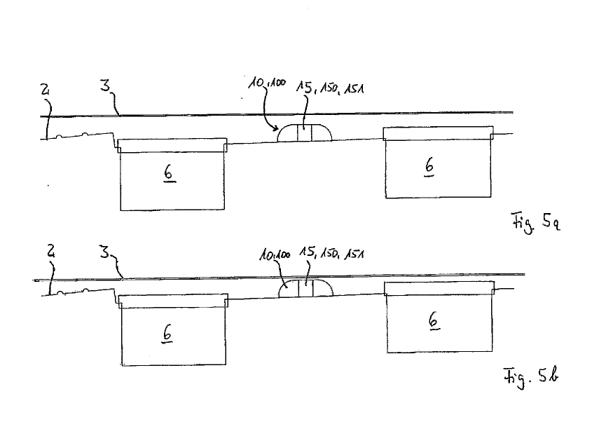

FIGS. 5a and 5b schematically illustrate how the spacing of this string 3 from the sensor array 15, 150, 151 on the control device 10, 100 arranged below the string 3 changes when a string 3 is shortened by being pressed down on a fret on the neck 2 of the electric guitar. A signal is triggered by the sensor array 15, 150, 151 by change in spacing transmitted to the microprocessor in the control device 10, 100, which uses that signal to generate corresponding control data in order to control the game console.

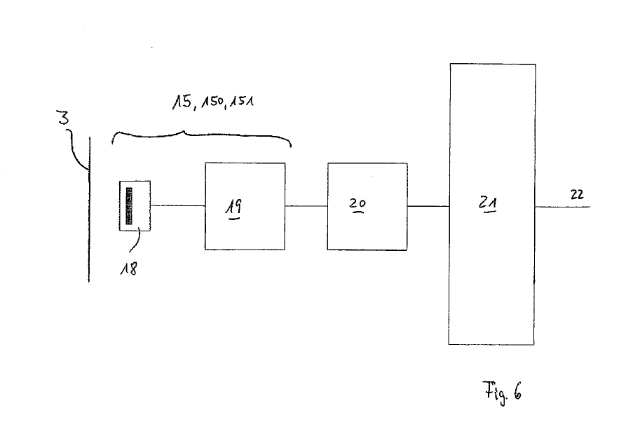

FIG. 6 schematically illustrates the structure of the signal processing in the control device. The sensor array 15 or 150, 151 comprises a resonant circuit 18 and a measurement circuit 19 connected with that resonant circuit. The resonant circuit 18 is excited with electrical energy and thus generates an electromagnetic field in which the string 3 is located. The change in the position of the string 3 relative to the resonant circuit 18 causes feedback to the voltage or current supply of the resonant circuit 18, which is evaluated in the measurement circuit 19. Accordingly, these signals that represent changes are then passed to the microprocessor 21 via an interface circuit 20, which may be designed as a separate circuit or integrated into the following microprocessor 21. There, the obtained data is evaluated and control data is generated therefrom on a control data output line 22 and transmitted to the game console in order to control that console. The data sets located on the control data output line g 22 are in a format usable by the game consoles, e.g. formatted as MIDI data.

When the control device according to the invention 10 or 100 is used in the manner shown in conjunction with an electric guitar, the microprocessor 21 evaluates measurement data received from the sensor arrays 15, 150, 151 according to the following criteria: Through a static change in the distance of the string 3 from the sensor array 15, 150 or 151, the microprocessor 21 determines that the associated string 3 has been pressed down. Through the corresponding change in spacing, the sensor array 15, 150, 151 can already make a rough pre-selection of the note that the operator intends to play and in addition, recognizes that the string thus pressed down will be articulated in the foreseeable future and that a note should be generated, and thus can already prepare for further data processing and the generation of control signals.

When the string is actually articulated, the sensor array 15, 150, 151 recognizes a dynamic change in spacing, which is evaluated in the microprocessor 21 in terms of amplitude, which produces a signal regarding the volume of the generated tone, and in terms of the frequency, which indicates the actual note produced. Additional evaluations may arise from the use of two sensor arrays 150, 151 per sensor field, in that the lateral displacement of the string as a result of so-called bending is also registered. The microprocessor 21 can also analyze such data in order to provide appropriate control signals on the control data output 22, which are transmitted to the game console and used to control the game running on that console, especially a simulation game of playing a lute-like instrument, especially an electric guitar.

It is important to note that no actual tones from the lute-like instrument are registered via the sensor arrays 15, 150, 151 in a manner that would allow this data to be used as an acoustic signal from the lute-like instrument. Because unlike pickups 6, which function electromagnetically, the sensor arrays 15, 150, 151 do not operate passively for the pure recording of the string vibrating in the environment of a fixed magnet and the electrical signal thus generated that follows the frequency response of the string, but rather are actively primed with a predetermined frequency. If one wished to amplify the electric signals obtained there as acoustic output, the natural frequency of the resonant circuit 18 would consistently be superimposed on these signals, but unlike the passive pickup circuit, the overtones that cannot be registered by such an arrangement would be lacking. The sensor arrays 15, 150, 151 thus only serve to determine the spacing of the strings, from which spacing the corresponding control data can be calculated and transmitted from the microprocessor 21 to the game console as control signals, e.g. in the MIDI data format.

Finally it is clear that the process previously explained, in particular with reference to FIG. 6, can be carried out just as well and without deviating from the inventive concept using elements permanently installed on the lute-like instrument (here, an electric guitar 1) including sensor arrays 15 or 150, 151 and associated circuits 20 as well as a microprocessor 21.

### LIST OF REFERENCE DRAWINGS

1 electric guitar
2 Neck
3, 3a-f String
4 Body
5 Fastening device
6 Pickup
7 Connection
10 Control device
11 Housing
12 Side section
13 Side section
14 Sensor section
15, 15a-f Sensor array
16 Control button
17 Control button
18 Resonant circuit
19 Measurement circuit
20 Interface circuit
21 Microprocessor
22 Control data output line
100 Control device
150, 150a-f Sensor array
151, 151 a-f Sensor array

1. A control device for a game console, comprising a housing (11), an electronic control element (21) arranged in the housing (11), input elements (16, 17, 15, 150, 151) arranged in the housing (11) and connected to the control element (21), and a data-transmission unit for transmitting control data to the game console wherein the housing (11) has a sensor section (14) in which input elements in the form of sensor fields are arranged in a number corresponding to the number of strings (3) of a lute instrument (1) and at a spacing corresponding to the spacing between the strings (3) of the lute instrument (1), wherein the control device (10, 100) is arranged such that it can be disposed with the sensor section (14) beneath the strings (3) of the lute-like instrument (1), wherein each sensor field lies below a string (3) without touching said string, and wherein the sensor fields are configured to detect a spacing between the respective associated string (3) and the sensor field, and to output a signal that represents this distance.

2. The control device according to claim 1, wherein sensor arrays (15, 150, 151) in the area of the sensor fields are arranged for inductive distance measurement.

3. The control device according to claim 2, in which, for each sensor field, two sensor arrays (150, 151) are arranged offset from one another, transversely with respect to the strings (3) that extend over the sensor field in the arrangement provided by the control device (10, 100), with the sensor section (14) thereof below the strings (3) of the lute instrument (1), for inductive distance measurement.

4. The control device according to claim 1, further comprising one of conventional control buttons (16, 17) and D-pads as additional input elements.

5. The control device according claim 1, in which the housing (11) has a flat central section, which forms the sensor section (14), and which features widened outer sections (12, 13) as compared with the center portions.

6. The control device according to claim 1, further comprising an electrical power supply, disposed in the housing (11).

7. The control device according to claim 6, further comprising a charging connector for connecting a charging cable with the electrical power supply.

8. The control device according to claim 1, in which the data-transmission unit features a transmission channel for the wireless transmission of control data to the game console.

9. The control device according to claim 1 in which the electronic control element (21) is a microprocessor.

10. The control device according to claim 1 further comprising a fastening element on the bottom for releasable attachment to the lute instrument (1) having the sensor section (14) arranged beneath the strings (3).

11. A method for generating control signals in order to control a game console using a lute-like instrument, in which at least one of the sensor arrays allocated to the respective string and provided for the output of a distance signal that correlates with the distance of the associated string to the sensor array is disposed beneath each string, so that via these sensor arrays, the changes in the distance of the strings from the respective sensor arrays that occur when the lute-like instrument is used by an operator during a game are recorded by those arrays and corresponding distance signals are sent to an evaluation unit, so that the distance signals from the sensor arrays are carried out in the evaluation unit with regard to the playing of the lute-like instrument and corresponding control signals usable by the game console are generated and outputted.

12. The method according to claim 11, in which the playing of the lute-like instrument is evaluated with respect to the tone sounded on the string, the volume thereof, and the temporal sequence of tones sounded.

13. The method according to claim 11 in which the control signals generated by the evaluation unit are generated using the MIDI standard for the game console.

14. The control device according to claim 6 in which the electrical power supply is a rechargeable battery.
